(19) United States
(12) Patent Application Publication
(10) Pub. No.: US 2025/0375741 A1
(43) Pub. Date: Dec. 11, 2025

(54) CARBON DIOXIDE SEPARATION MEMBRANE

(71) Applicant: TOYOTA JIDOSHA KABUSHIKI KAISHA, Toyota-shi (JP)

(72) Inventors: Koseki SUGIYAMA, Sunto-gun (JP); Yoshiteru Yazawa, Nagoya-shi (JP)

(73) Assignee: TOYOTA JIDOSHA KABUSHIKI KAISHA, Toyota-shi (JP)

(21) Appl. No.: 19/066,428

(22) Filed: Feb. 28, 2025

(30) Foreign Application Priority Data
Jun. 10, 2024 (JP) 2024-093433

(51) Int. Cl. B01D 69/12; B01D 71/06

(52) U.S. Cl. CPC B01D 69/1216; B01D 71/06; B01D 2257/504

(57) ABSTRACT

A carbon dioxide separation membrane according to the disclosure includes: a porous substrate; a protective layer provided on a surface of the substrate and having a higher density than the substrate; and a separation layer provided on a surface of the protective layer and containing a substance having a high affinity for carbon dioxide, wherein the protective layer has a thickness of 15 nm or less, and the separation layer has a thickness of 300 nm or less.

### CROSS-REFERENCE TO RELATED APPLICATION

This application claims priority to Japanese Patent Application No. 2024-093433 filed on Jun. 10, 2024. The disclosure of the above-identified application, including the specification, drawings, and claims, is incorporated by reference herein in its entirety.

### BACKGROUND

### 1. Technical Field

The disclosure relates to a carbon dioxide separation membrane.

### 2. Description of Related Art

A method for separating and capturing carbon dioxide from a mixed gas using a separation membrane has been known. WO 2013-180218 discloses a carbon dioxide separation membrane including a polymer resin and a separation layer in which an organic liquid having a high affinity for carbon dioxide is immobilized on the polymer resin. Since the carbon dioxide separation membrane disclosed in WO 2013-180218 has the separation layer having a high affinity for carbon dioxide, it is possible to selectively separate carbon dioxide from a mixed gas.

### SUMMARY

In recent years, there has been a demand for selectively and highly efficiently capturing carbon dioxide from a mixed gas containing a low concentration, such as a few percent or less, of carbon dioxide. However, when the separation layer is provided as in WO 2013-180218, it is physically difficult for gas molecules to pass through the membrane, and consequently, carbon dioxide permeation flux decreases, and carbon dioxide cannot be efficiently captured.

The disclosure has been made in consideration of such circumstances, and provides a carbon dioxide separation membrane capable of efficiently capturing carbon dioxide from a mixed gas containing a low concentration of carbon dioxide.

A carbon dioxide separation membrane according to the disclosure includes: a porous substrate; a protective layer provided on a surface of the substrate and having a higher density than the substrate; and a separation layer provided on a surface of the protective layer and containing a substance having a high affinity for carbon dioxide, wherein the protective layer has a thickness of 15 nm or less, and the separation layer has a thickness of 300 nm or less.

According to the disclosure, it is possible to provide a carbon dioxide separation membrane capable of efficiently capturing carbon dioxide from a mixed gas containing a low concentration of carbon dioxide.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein

FIG. 1 is a sectional view of a carbon dioxide separation membrane according to the embodiment.

### DETAILED DESCRIPTION OF EMBODIMENTS

Hereinafter, a specific embodiment to which the disclosure is applied will be described in detail while referring to the drawings. Note that the disclosure is not limited to the following embodiment. Moreover, the following descriptions and drawings are simplified as appropriate for clarity of explanation. Furthermore, a plurality of configuration examples described below can be implemented independently or in appropriate combinations. These configuration examples have mutually different novel features. Therefore, these configuration examples contribute to solving mutually different purposes or problems, and contribute to providing mutually different effects.

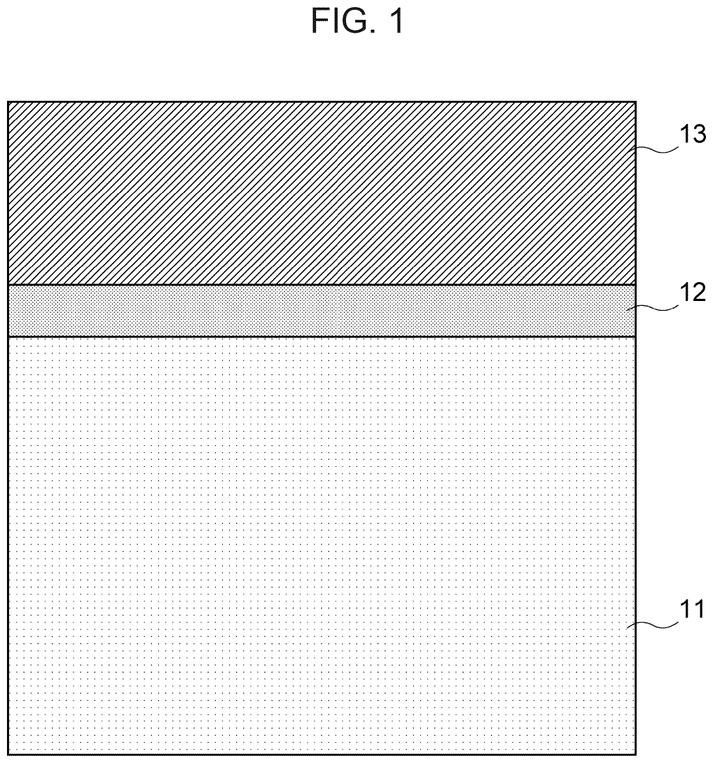

FIG. 1 is a sectional view of a carbon dioxide separation membrane 1 according to the embodiment. The carbon dioxide separation membrane 1 includes a porous substrate 11, a protective layer 12 provided on a surface of the substrate 11, and a separation layer 13 provided on a surface of the protective layer 12.

The structure and the like of the substrate 11 is not particularly limited as long as the substrate 11 is a porous material, and, for example, a hollow fiber or another filtration membrane can be used. In this case, from the viewpoint of permeating carbon dioxide highly selectively and at a high flow rate, it is preferable to use an ultra-filtration membrane (UF membrane) or a micro-filtration membrane (MF membrane) for the substrate 11. The material of the substrate 11 is, for example, polyethersulfone, polysulfone, polyacrylonitrile, cellulose acetate, polyvinylidene fluoride, tetrafluoroethylene, polyethylene, polypropylene, polyvinyl alcohol, or the like.

The protective layer 12 is a layer having a higher density than the substrate 11. The thickness of the protective layer 12 is 15 nm or less, preferably 10 nm or less. The lower limit of the thickness of the protective layer 12 is within a range that does not impair the effects of the disclosure, and may be, for example, 1 nm or more. Although the material of the protective layer 12 is not particularly limited as long as being a substance that can be fixed to the substrate 11, the material is preferably hydrophilic from the viewpoint of increasing the affinity with the separation layer 13.

The protective layer 12 can be provided on the surface of the substrate 11 by a known film formation method. Alternatively, a portion in the vicinity of the surface of the substrate 11 may be deformed by applying pressure or heat to increase the density of the portion and make the portion into the protective layer 12. From the viewpoint of ease of manufacturing, the substrate 11 and the protective layer 12 are preferably formed from the same layer in this manner.

The separation layer 13 is a layer containing a substance having a high affinity for carbon dioxide. As the substance, for example, polyvinyl alcohol, polyacrylic acid, polyethyleneimine, polyallylamine, or copolymers thereof can be used. From the viewpoint of the excellent carrying property of an amine compound described later, the separation layer 13 preferably contains polyacrylic acid, polyethyleneimine, polyallylamine, or a copolymer containing these substances.

The separation layer 13 can be provided on the surface of the protective layer 12 by a known film formation method. For example, the separation layer 13 can be formed by applying a liquid containing a substance having a high affinity for carbon dioxide onto the protective layer 12 and drying the liquid. At this time, the protective layer 12 performs the function of preventing the component of the separation layer 13 from permeating into the substrate 11. Therefore, the separation layer 13 can be formed thin.

The thickness of the separation layer 13 is 300 nm or less, preferably 210 nm or less, more preferably 100 nm or less. The thinner the separation layer 13, the greater the carbon dioxide permeation flux, and therefore the thinner separation layer 13 is preferable. The lower limit of the thickness of the separation layer 13 is within a range that does not impair the effects of the disclosure, and, from the viewpoint of selectively separating carbon dioxide, the thickness is preferably greater than or equal to 10 times the thickness of the protective layer 12.

In the carbon dioxide separation membrane 1 having the above configuration, carbon dioxide is selectively taken into the separation layer 13 from a mixed gas in contact with the surface of the separation layer 13, and moves to the substrate 11 via the protective layer 12. Thus, carbon dioxide can be selectively separated. Moreover, since the thickness of the separation layer 13 is as thin as 300 nm, it is possible to keep a sufficiently large permeation flux of carbon dioxide. Therefore, it is possible to efficiently capture carbon dioxide from the mixed gas containing a low concentration of carbon dioxide.

Note that the separation layer 13 preferably further contains an amine compound. When the separation layer 13 contains an amine compound, carbon dioxide is adsorbed on the amine compound and transported, thereby improving the separation selectivity of carbon dioxide. From the viewpoint of improving the transport efficiency of carbon dioxide, the amine compound is preferably an amine compound other than polymers, more preferably alkanolamines or diethylenetriamine, and particularly preferably diethylenetriamine.

Hereinafter, the disclosure will be described more specifically by examples, but the disclosure is not limited to these examples.

The following materials were used for manufacturing examples and comparative examples.

### Materials

### Supports

Support A: Among hollow fiber membrane modules “SLP-0053” manufactured by Asahi Kasei Corporation, a module in which the area from the surface to a depth of 10 nm was formed at a higher density than the inside was used as a support A. In other words, a hollow fiber substrate and a high-density protective layer formed integrally on the surface of the hollow fiber substrate were used as the support A.

Support B: Among the hollow fiber membrane modules of the same type as the support A but from a different manufacturing lot, a module formed with similar density both in the vicinity of the surface and the inside was used as a support B. In other words, a hollow fiber substrate having no protective layer formed on the surface was used as the support B.

### Coating Solutions

Coating solution a: an aqueous solution having a concentration of polyvinyl alcohol of 2 mass % was used as a coating solution a.

Coating solution b: an aqueous solution having a concentration of polyvinyl alcohol of 2 mass % and a concentration of diethylenetriamine of 20 mass % was used as a coating solution b.

A method for manufacturing examples and comparative examples are as follows.

### Manufacturing Method

Example 1: a carbon dioxide separation membrane of Example 1 was produced by applying the coating solution a to the module of support A.

Example 2: a carbon dioxide separation membrane of Example 2 was produced by applying the coating solution b to the module of support A.

Comparative Example 1: the support B was used as it was for a carbon dioxide separation membrane of Comparative Example 1.

Comparative Example 2: a carbon dioxide separation membrane of Comparative Example 2 was produced by applying the coating solution a to the module of support B.

Comparative Example 3: a carbon dioxide separation membrane of Comparative Example 3 was produced by applying the coating solution b to the module of support B.

Note that the coating solution application method was implemented based on the description in a document (DUAN, Shuhong, et al., Development of PAMAM dendrimer composite membranes for CO₂ separation, Journal of membrane science, 2006, 283. 1-2:2-6.).

### Evaluation

For structural evaluation, the thicknesses of the protective layer and the separation layer in each example were measured from cross-sectional scanning electron microscope (SEM) images. Moreover, for performance evaluation, a mixed gas containing a low concentration of carbon dioxide was brought into contact with each separation membrane under the same conditions, and the CO₂ permeation flux and CO₂/N₂ selectivity were measured. The results are shown in Table 1.

Note that the unit of permeation flux, GPU, in Table 1 is 1 [GPU]=3.35×10⁻⁷ [mol/m²·s·kPa].

TABLE 1

| | | | Protective | Separation | CO₂ | |
|---|---|---|---|---|---|---|
| | | | layer | layer | permeation | CO₂/N₂ |
| | Support | Coating Solution | [nm] | [nm] | flux [GPU] | selectivity |
| Example 1 | Support | Solution a | 10 | 160 | 1300 | 10 |
| | A | (polyvinyl alcohol) | | | | |
| Example 2 | Support | Solution b | 10 | 200 | 2000 | 1000 |
| | A | (polyvinyl alcohol + | | | | |
| | | diethylenetriamine) | | | | |
| Comparative | Support | — | — | — | 13000 | 1 |
| Example 1 | B | | | | | |
| Comparative | Support | Solution a | — | 1000 | 130 | 10 |
| Example 2 | B | (polyvinyl alcohol) | | | | |
| Comparative | Support | Solution b | — | 1000 | 160 | 360 |
| Example 3 | B | (polyvinyl alcohol + | | | | |
| | | diethylenetriamine) | | | | |

As shown in Table 1, Examples 1 and 2 having the separation layer had higher CO₂/N₂ selectivity than Comparative Example 1 having no separation layer.

Moreover, in Comparative Examples 2 and 3, the components of the coating solution permeated to a depth of 1000 nm from the substrate surface, and the separation layers were formed thick, whereas, in Examples 1 and 2, the separation layers were formed relatively thin. Consequently, Examples 1 and 2 had higher CO₂ permeation flux than Comparative Examples 2 and 3.

The results showed that the carbon dioxide separation membrane of the disclosure can efficiently capture carbon dioxide from the mixed gas containing a low concentration of carbon dioxide.

Note that the disclosure is not limited to the above embodiment, and can be modified as appropriate within a range not departing from the gist of the disclosure.

What is claimed is:

1. A carbon dioxide separation membrane comprising:
a porous substrate;
a protective layer provided on a surface of the substrate and having a higher density than the substrate; and
a separation layer provided on a surface of the protective layer and containing a substance having a high affinity for carbon dioxide, wherein
the protective layer has a thickness of 15 nm or less, and
the separation layer has a thickness of 300 nm or less.

2. The carbon dioxide separation membrane according to claim 1, wherein the separation layer contains an amine compound other than polymers.

3. The carbon dioxide separation membrane according to claim 2, wherein the amine compound is diethylenetriamine.

4. The carbon dioxide separation membrane according to claim 1, wherein the thickness of the protective layer is less than or equal to one-tenth of the thickness of the separation layer.
